(19) United States
(12) Patent Application Publication
(10) Pub. No.: US 2024/0321498 A1
(43) Pub. Date: Sep. 26, 2024

(54) MAGNETIC COMPONENT

(71) Applicant: CYNTEC CO., LTD., Hsinchu (TW)

(72) Inventors: Yung-Shou Hsu, Hsinchu (TW); Chien-Lin Chen, Hsinchu (TW); Shao-Wei Chang, Hsinchu (TW); Chun-Ying Liao, Hsinchu (TW); Hsieh-Shen Hsieh, Hsinchu (TW); Ying-Teng Chang, Hsinchu (TW); Chia-Hao Yang, Hsinchu (TW)

(73) Assignee: CYNTEC CO., LTD., Hsinchu (TW)

(21) Appl. No.: 18/613,093

(22) Filed: Mar. 21, 2024

Related U.S. Application Data
(60) Provisional application No. 63/454,623, filed on Mar. 24, 2023.

(51) Int. Cl. H01F 27/02; H01F 27/28; H01F 27/32

(52) U.S. Cl. CPC H01F 27/025; H01F 27/2823; H01F 27/2847; H01F 27/325; H01F 27/327

(57) ABSTRACT

A magnetic component includes a core and at least one coil. The core includes at least one outer leg and an inner leg. The inner leg is separated from an upper inner surface of the core. The inner leg is at least partially divided into a plurality of separated portions along a length direction of the inner leg. The at least one coil is wound around the inner leg.

### CROSS REFERENCE TO RELATED APPLICATIONS

This application claims the benefit of U.S. Provisional Application No. 63/454,623, filed on Mar. 24, 2023. The content of the application is incorporated herein by reference.

### BACKGROUND OF THE INVENTION

### 1. Field of the Invention

The invention relates to a magnetic component and, more particularly, to a magnetic component capable of effectively improving heat dissipating efficiency.

### 2. Description of the Related Art

In response to the demand for fast charging of electric vehicles, the operating power is getting bigger and bigger, such that the heat generated by electronic components is also getting higher and higher. A magnetic component of an on-board charger (OBC), such as transformer, will generate heat due to loss during operation, and the uneven heat will generate additional thermal stress on a core of the transformer. The thermal stress will increase the loss of the core of the transformer, and the heat will not converge under continuous cycles, thereby resulting in excessively high temperature and loss. Consequently, it will cause irreversible damage to the core in severe cases.

### SUMMARY OF THE INVENTION

The invention provides a magnetic component capable of effectively improving heat dissipating efficiency, so as to solve the aforesaid problems.

According to an embodiment of the invention, a magnetic component comprises a core and at least one coil. The core comprises at least one outer leg and an inner leg. The inner leg is separated from an upper inner surface of the core. The inner leg is at least partially divided into a plurality of separated portions along a length direction of the inner leg. The at least one coil is wound around the inner leg.

In this embodiment, the inner leg is separated from the upper inner surface of the core and at least partially divided into a plurality of separated portions along the length direction of the inner leg. Since the inner leg has the highest temperature and the heat cannot be easily dissipated from the inner leg, the inner leg at least partially divided into a plurality of separated portions along the length direction of the inner leg can reduce the cross-sectional area of the inner leg perpendicular to the magnetic flux direction, so as to reduce the eddy current loss of the core.

In an embodiment, the magnetic component further comprises a heat dissipating member and a thermal conductive filler. The heat dissipating member is disposed on the core. The heat dissipating member is in contact with a top surface and a side surface of the core. The side surface has an opening. The heat dissipating member covers the opening. The thermal conductive filler is filled at the opening of the side surface and covers a part of the at least one coil rather than wholly covering the at least one coil. A shape of the thermal conductive filler at the opening is identical to a shape of the opening covered by the heat dissipating member. An end of the at least one coil protrudes from the core. The heat dissipating member has a protruding portion thermally coupled to the end of the at least one coil.

In this embodiment, the heat dissipating member covers the opening of the side surface of the core, and the thermal conductive filler is filled at the opening of the side surface and covers a part of the at least one coil rather than wholly covering the at least one coil, such that the usage amount of the thermal conductive filler can be saved.

In an embodiment, the at least one coil comprises an upper first coil, a lower first coil and a second coil. A cross-sectional area of each of the upper first coil and the lower first coil is larger than a cross-sectional area of the second coil. The upper first coil is disposed with respect to the upper inner surface of the core. The lower first coil is disposed with respect to a lower inner surface of the core. The second coil is disposed between the upper first coil and the lower first coil. The lower first coil, the second coil and the upper first coil are stacked from bottom to top. There is a gap between the upper inner surface of the core and the upper first coil. The magnetic component further comprises a thermal conductive material partially disposed in the gap and in contact with the upper first coil and the upper inner surface of the core. There is no gap between the lower inner surface of the core and the lower first coil. The lower first coil is thermally coupled to the lower inner surface of the core. The second coil is not in contact with the thermal conductive material.

In this embodiment, since the thermal conductive material is partially disposed in the gap between the upper inner surface of the core and the upper first coil, the heat of the upper first coil can be transferred to the upper portion of the core through the thermal conductive material, so as to dissipate the heat from the upper first coil.

In an embodiment, the magnetic component further comprises a first heat dissipating member and a second heat dissipating member. The first heat dissipating member is disposed on a first side and a top side of the core. The first heat dissipating member extends from the first side to the top side. The second heat dissipating member is disposed on a second side and the top side of the core. The first side is opposite to the second side. The second heat dissipating member extends from the second side to the top side. The first heat dissipating member and the second heat dissipating member have a first joint region, a second joint region and a third joint region on the top side between the first side and the second side. The third joint region is located between the first joint region and the second joint region. Projections of the first joint region and the second joint region do not overlap with the inner leg. A projection of at least one of the first heat dissipating member and the second heat dissipating member overlaps with the inner leg.

In this embodiment, the projection of at least one of the first heat dissipating member and the second heat dissipating member overlaps with the inner leg, such that the heat of the inner leg can be transferred to the thermal conductive filler on the side or below through at least one of the first heat dissipating member and the second heat dissipating member, and then transferred to the heat dissipating surface below. Furthermore, the projections of the first joint region and the second joint region do not overlap with the inner leg, such that the joint distance of each of the first joint region and the second joint region may be larger than the joint distance of the third joint region to absorb the larger length tolerance of the first heat dissipating member or the second heat dissipating member in the horizontal direction of the core without affecting the heat dissipating efficiency.

In an embodiment, the magnetic component further comprises a plastic casing, an insulating and thermal conductive substrate, and a thermal conductive filler. The plastic casing is disposed on the insulating and thermal conductive substrate. The core is disposed in the plastic casing and located on the insulating and thermal conductive substrate. The thermal conductive filler is filled in the plastic casing.

When the magnetic component with a casing made of aluminum is applied to a high-voltage device (e.g. larger than 67V), it is necessary to dispose an insulating layer inside the casing, which is costly and has poor insulation. Thus, in this embodiment, the casing of the magnetic component made of plastic not only has better insulation, but also can concentrate and transfer most of the heat to the insulating and thermal conductive substrate on the bottom. Furthermore, when filling the thermal conductive filler, the plastic casing can be used to cover the thermal conductive filler.

In an embodiment, the magnetic component further comprises a casing. The casing has a support structure. A terminal is disposed on the support structure. An end of the at least one coil is bonded with the terminal on the support structure. The support structure extends downward from the terminal to a support plane where the casing is located.

In this embodiment, since the support structure extends downward from the terminal to the support plane where the casing of the magnetic component is located, the bonding force for bonding the end of the coil with the terminal will be directly transferred to the support plane through the support structure, such that the support structure may withstand, for example, 650 tons of the bonding force.

In an embodiment, the at least one coil comprises at least one primary coil and at least one secondary coil stacked with each other. The at least one primary coil is formed by stacking a circular wire in multiple turns. The at least one secondary coil is a foil structure. The at least one secondary coil has a heat dissipating portion protruding from the core. The at least one primary coil is retracted between the at least one secondary coil without extending to the heat dissipating portion of the at least one secondary coil. The magnetic component further comprises a thermal conductive filler partially filled between the at least one primary coil and the at least one secondary coil.

In this embodiment, the heat dissipating portion of the secondary coil may be in contact with a heat dissipating surface of a radiator, so as to increase the heat dissipating area of the magnetic component. Furthermore, the heat of the retracted primary coil can be transferred to an external heat dissipating interface through the thermal conductive filler and the secondary coil, so as to achieve better heat dissipating efficiency in a more economical (lower cost) manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is a sectional view illustrating the magnetic component shown in FIG. 1.

FIG. 3 is a top view illustrating an inner leg shown in FIG. 2.

FIG. 4 is a sectional view illustrating the magnetic component according to another embodiment of the invention.

FIG. 5 is a sectional view illustrating the magnetic component according to another embodiment of the invention.

FIG. 6 is a perspective view illustrating a magnetic component according to another embodiment of the invention.

FIG. 7 is a partial exploded view illustrating the magnetic component shown in FIG. 6.

FIG. 8 is a perspective view illustrating a thermal conductive filler covering a part of the coil rather than wholly covering the coil.

FIG. 9 is a sectional view illustrating the magnetic component shown in FIG. 6.

FIG. 10 is a perspective view illustrating a magnetic component according to another embodiment of the invention.

FIG. 11 is a partial exploded view illustrating the magnetic component shown in FIG. 10.

FIG. 12 is a sectional view illustrating the magnetic component shown in FIG. 10.

FIG. 13 is a perspective view illustrating a magnetic component according to another embodiment of the invention.

FIG. 14 is a partial exploded view illustrating the magnetic component shown in FIG. 13.

FIG. 15 is a sectional view illustrating the magnetic component shown in FIG. 13 along line X-X.

FIG. 16 is a sectional view illustrating the magnetic component shown in FIG. 13 along line Y-Y.

FIG. 17 is a top view illustrating the magnetic component according to another embodiment of the invention.

FIG. 18 is a top view illustrating the magnetic component according to another embodiment of the invention.

FIG. 19 is a perspective view illustrating a magnetic component according to another embodiment of the invention.

FIG. 20 is an exploded view illustrating the magnetic component shown in FIG. 19

FIG. 21 is a sectional view illustrating the magnetic component shown in FIG. 19.

FIG. 22 is a perspective view illustrating a magnetic component according to another embodiment of the invention.

FIG. 23 is a sectional view illustrating the magnetic component shown in FIG. 22.

FIG. 24 is a perspective view illustrating a magnetic component according to another embodiment of the invention.

FIG. 25 is an exploded view illustrating the magnetic component shown in FIG. 24.

FIG. 26 is an exploded view illustrating the secondary coils and the insulating spacers shown in FIG. 25.

FIG. 27 is a sectional view illustrating the magnetic component shown in FIG. 24.

### DETAILED DESCRIPTION

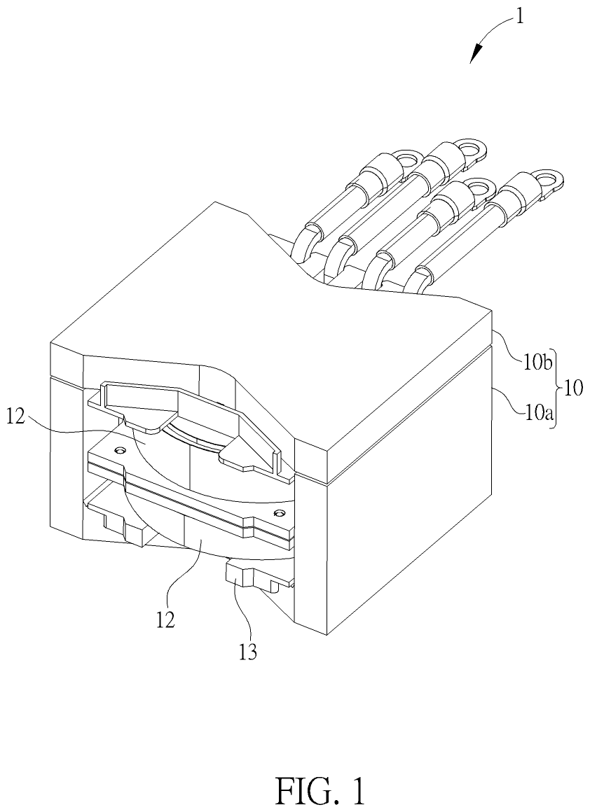

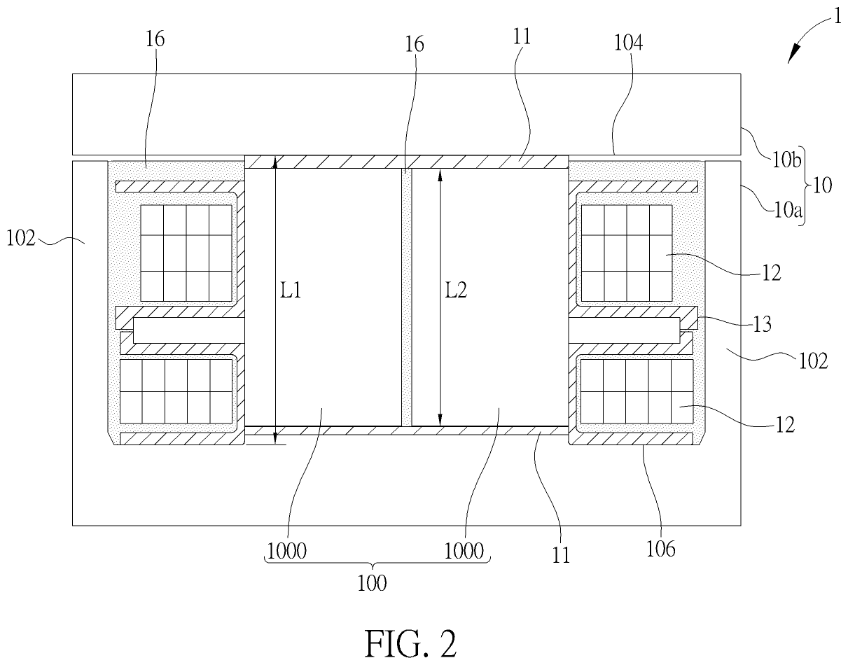

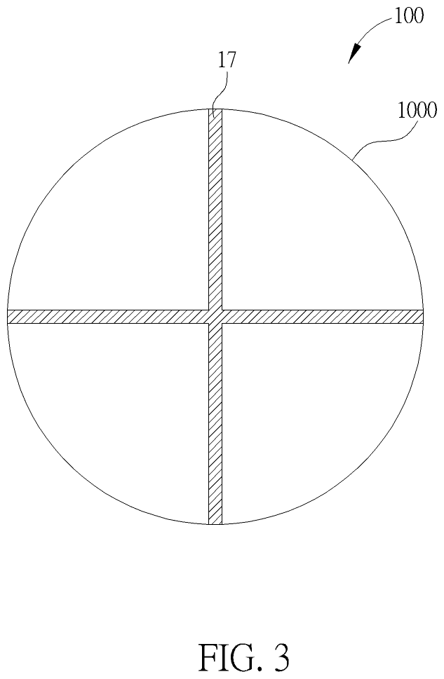

Referring to FIGS. 1 to 3, FIG. 1 is a perspective view illustrating a magnetic component 1 according to an embodiment of the invention, FIG. 2 is a sectional view illustrating the magnetic component 1 shown in FIG. 1, and FIG. 3 is a top view illustrating an inner leg 100 shown in FIG. 2.

The magnetic component 1 of the invention may be a reactor, a transformer, an inductor or other magnetic components. As shown in FIGS. 1 and 2, the magnetic component 1 comprises a core 10, at least one coil 12 and a bobbin 13. The core 10 comprises an inner leg 100 and at least one outer leg 102. In this embodiment, the core 10 may comprise a first core member 10a and a second core member 10b disposed on the first core member 10a, wherein the inner leg 100 may be a central pillar disposed between the first core member 10a and the second core member 10b, and two outer legs 102 may be side pillars extending from the periphery of the first core member 10a. It should be noted that the types of the first core member 10a and the second core member 10b may be determined according to practical applications, so the invention is not limited to the embodiment shown in the figure.

In this embodiment, the at least one coil 12 is wound around the inner leg 100, and there is no coil wound around the outer legs 102. The type of the coil 12 may be a circular wire, a rectangular wire or a multi-stranded wire. The inner leg 100 is separated from an upper inner surface 104 of the core 10. In this embodiment, the inner leg 100 (at least one individual portion of the inner leg 100) may be further separated from a lower inner surface 106 of the core 10, such that the inner leg 100 is floated or separated between the upper inner surface 104 and the lower inner surface 106. The upper inner surface 104 may be provided by the second core member 10b and the lower inner surface 106 may be provided by the first core member 10a. The bobbin 13 is disposed between the first core member 10a and the second core member 10b to support the floated inner leg 100. The at least one coil 12 is wound around the bobbin 13 and the inner leg 100. Furthermore, a spacer 11 may be disposed between the inner leg 100 and the upper inner surface 104 of the core 10, and another spacer 11 may be disposed between the inner leg 100 and the lower inner surface 106 of the core 10.

As shown in FIG. 3, the inner leg 100 is at least partially divided into a plurality of separated portions 1000 along a length direction of the inner leg 100. Preferably, a length L2 of the plurality of separated portions 1000 may be larger than ⅓ of a length L1 of overall the inner leg 100 between the upper inner surface 104 of the core 10 and the lower inner surface 106 of the core 10. In this embodiment, the length L2 of the plurality of separated portions 1000 may be equal to the length L1 of overall the inner leg 100, i.e. the inner leg 100 may be completely cut along the length direction to form the plurality of separated portions 1000, as shown in FIG. 2. Furthermore, the inner leg 100 may be cut through a center, and volumes of the plurality of separated portions 1000 may be identical to each other. As shown in FIG. 3, the inner leg 100 may be equally divided into four separated portions 1000 along the length direction of the inner leg 100, but the invention is not so limited. The number, volume and length of the separated portions 1000 may be determined according to practical applications. Still further, a thermal conductive filler 16 may be filled between the separated portions 1000 to improve heat dissipating efficiency, as shown in FIG. 2. A thermal conductivity of the thermal conductive filler 16 may be greater than 0.3 W/mk, and a material of the thermal conductive filler may comprise epoxy, silicone, polyurethane (PU), phenolic resins, thermoplastic polyethylene terephthalate (PET), polyamide (PA), polyphenylene sulfide (PPS), polyetheretherketone (PEEK) and so on. Moreover, in some embodiments, a thermal conductive sheet 17 (e.g. metal sheet or ceramic sheet, as shown in FIG. 3) with a thermal conductivity greater than the thermal conductive filler 16 may be disposed between the separated portions 1000 of the inner leg 10 and combined with the thermal conductive filler 16 covering the inner leg 100, thereby reducing core loss, temperature of inner leg and core stress.

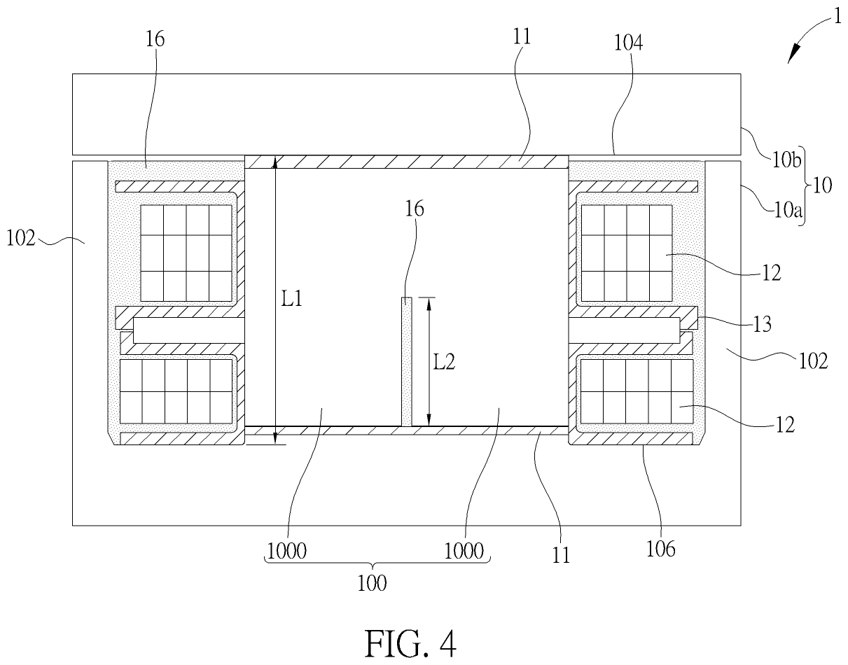

Referring to FIG. 4, FIG. 4 is a sectional view illustrating the magnetic component 1 according to another embodiment of the invention. As shown in FIG. 4, the length L2 of the plurality of separated portions 1000 may be equal to ½ of the length L1 of overall the inner leg 100.

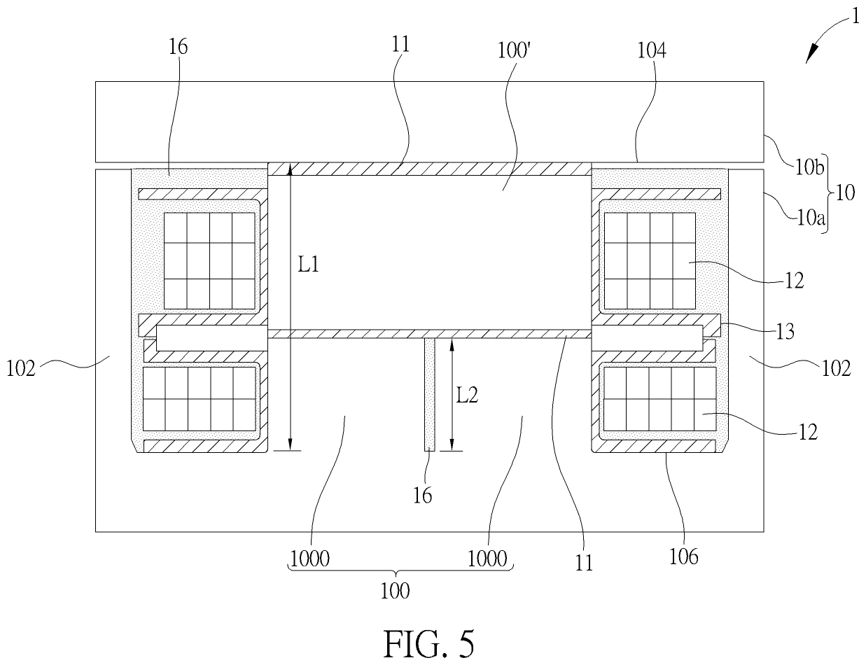

Referring to FIG. 5, FIG. 5 is a sectional view illustrating the magnetic component 1 according to another embodiment of the invention. As shown in FIG. 5, the inner leg 100 may be connected to the first core member 10a and there may be a floated (or separated) inner leg 100′ located above the inner leg 100, and the length L2 of the plurality of separated portions 1000 may be equal to ½ of the length L1 of overall the inner leg 100. Similar to the embodiment shown in FIG. 4, the length L2 of the plurality of separated portions 1000 shown in FIG. 5 may also be equal to ½ of the length L1 of overall the inner leg 100. Furthermore, a spacer 11 may be disposed between the inner leg 100′ and the upper inner surface 104 of the core 10, and another spacer 11 may be disposed between the inner leg 100 and the inner leg 100′.

As mentioned in the above, the inner leg 100 is separated from the upper inner surface 104 of the core 10 and at least partially divided into a plurality of separated portions 1000 along the length direction of the inner leg 100. Since the inner leg 100 has the highest temperature and the heat cannot be easily dissipated from the inner leg 100, the inner leg 100 at least partially divided into a plurality of separated portions 1000 along the length direction of the inner leg 100 can reduce the cross-sectional area of the inner leg 100 perpendicular to the magnetic flux direction, so as to reduce the eddy current loss of the core 10. Furthermore, the invention only cuts the inner leg 100 without cutting the first core member 10a and/or the second core member 10b. Thus, the structure of the invention is easy to be assembled and the assembly tolerance is small.

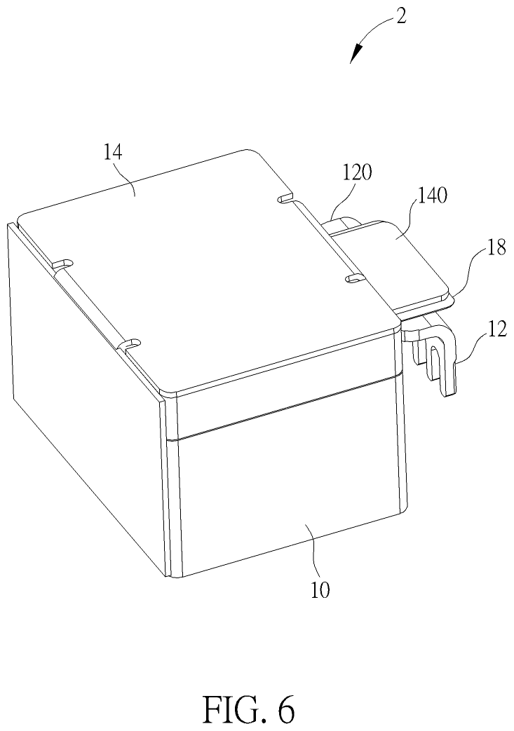

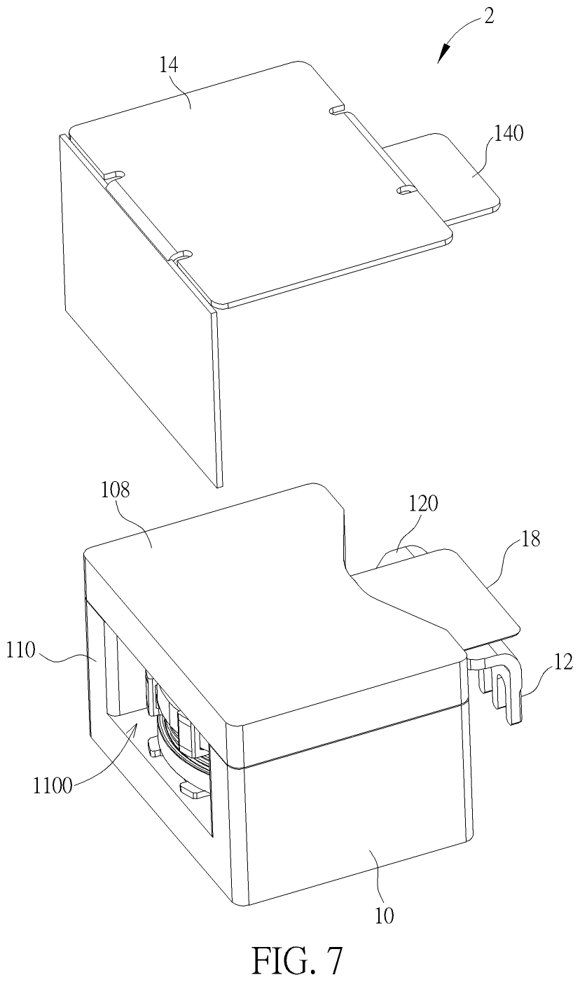

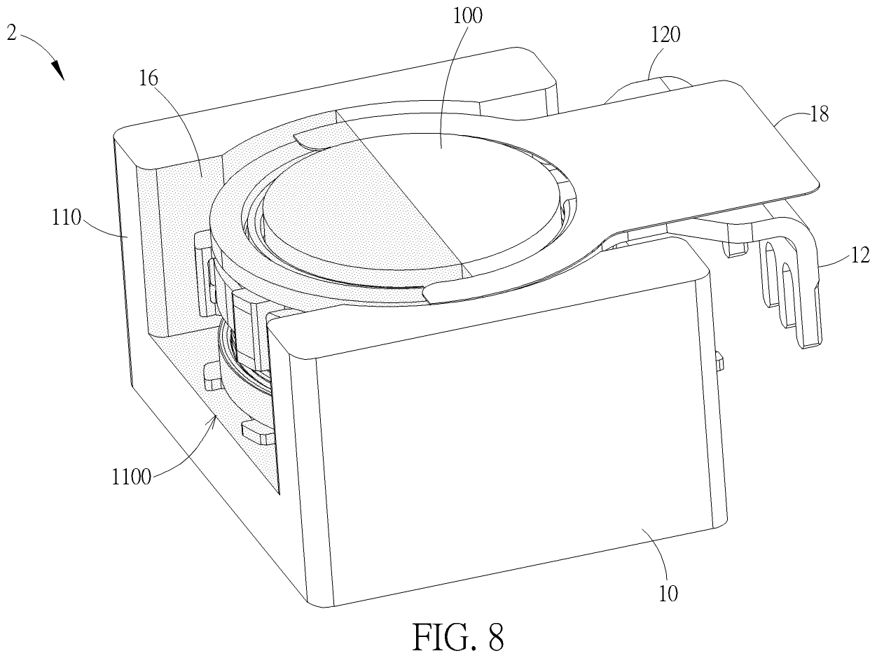

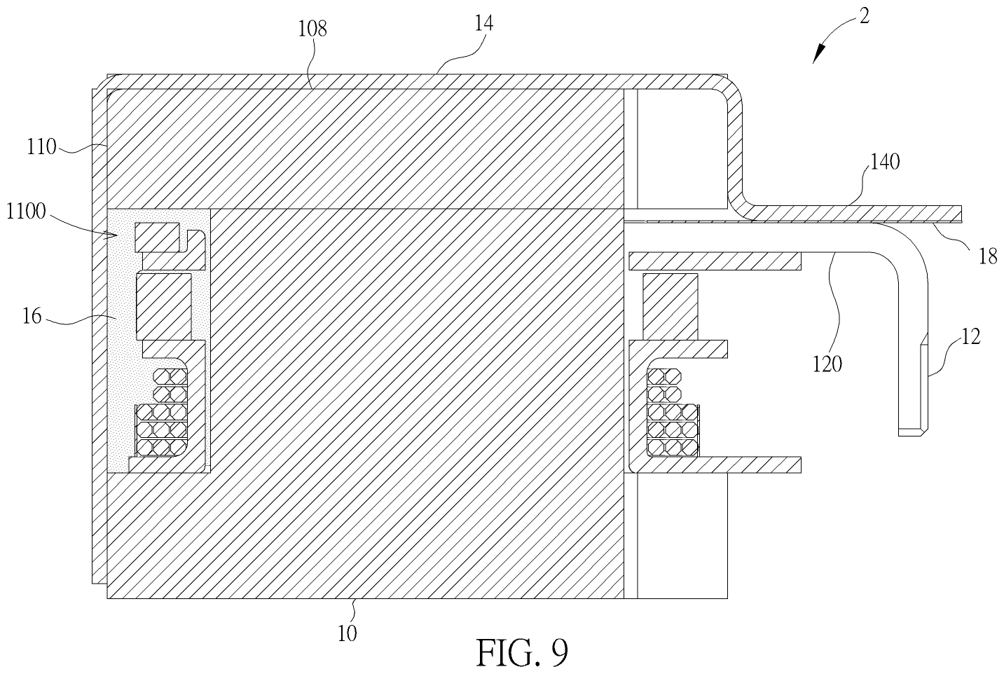

Referring to FIGS. 6 to 9, FIG. 6 is a perspective view illustrating a magnetic component 2 according to another embodiment of the invention, FIG. 7 is a partial exploded view illustrating the magnetic component 2 shown in FIG. 6, FIG. 8 is a perspective view illustrating a thermal conductive filler 16 covering a part of the coil 12 rather than wholly covering the coil 12, and FIG. 9 is a sectional view illustrating the magnetic component 2 shown in FIG. 6.

In an embodiment, the magnetic component 2 further comprises a heat dissipating member 14, a thermal conductive filler 16 and an insulating member 18, as shown in FIGS. 6 to 9. The heat dissipating member 14 is disposed on the core 10, wherein the heat dissipating member 14 is in contact with a top surface 108 and a side surface 110 of the core 10. The side surface 110 has an opening 1100 and the heat dissipating member 14 covers the opening 1100. The thermal conductive filler 16 is filled at the opening 1100 of the side surface 110 and covers a part of the at least one coil 12 rather than wholly covering the at least one coil 12, as shown in FIG. 8. In this time, a shape of the thermal conductive filler 16 at the opening 1100 is identical to a shape of the opening 1100 covered by the heat dissipating member 14. Furthermore, an end 120 of the at least one coil 12 may protrude from the core 10, and the heat dissipating member 14 may have a protruding portion 140 thermally coupled to the end 120 of the at least one coil 12.

For further explanation, after the heat dissipating member 14 covers the opening 1100, the thermal conductive filler 16 is filled into the core 10 from another opening opposite to the opening 1100, such that the thermal conductive filler 16 is filled at the opening 1100 and covers a part of the at least one coil 12 close to the opening 1100 without covering another part of the at least one coil 12 away from the opening 1100. Accordingly, the usage amount of the thermal conductive filler 16 can be saved. To balance the temperature, the coil 12 not covered by the thermal conductive filler 16 may be thermally coupled to the protruding portion 140 of the heat dissipating member 14.

In this embodiment, the insulating member 18 may be disposed between the end 120 of the at least one coil 12 and the protruding portion 140 of the heat dissipating member 14. The insulating member 18 can prevent the protruding portion 140 from contacting both ends of the coil 12 at the same time to cause short circuit. In some embodiments, the outer surface of the heat dissipating member 14 may have a thicker electrical insulating layer, such that the insulating member 18 may be omitted.

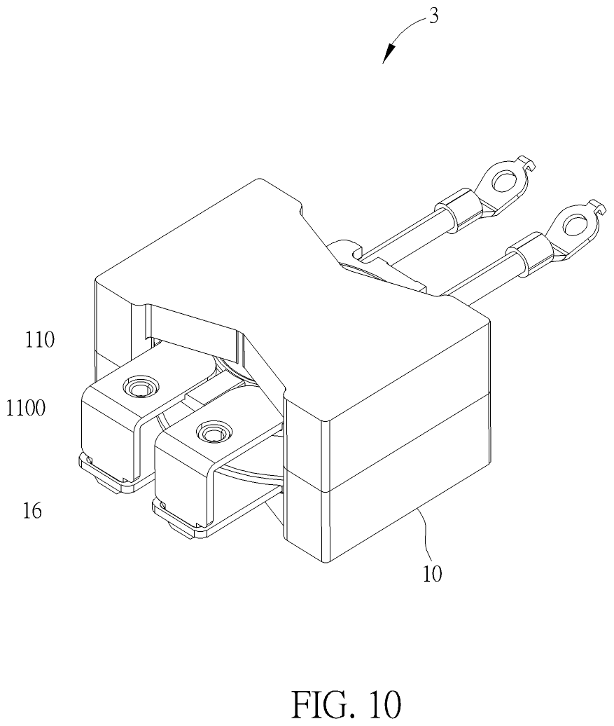

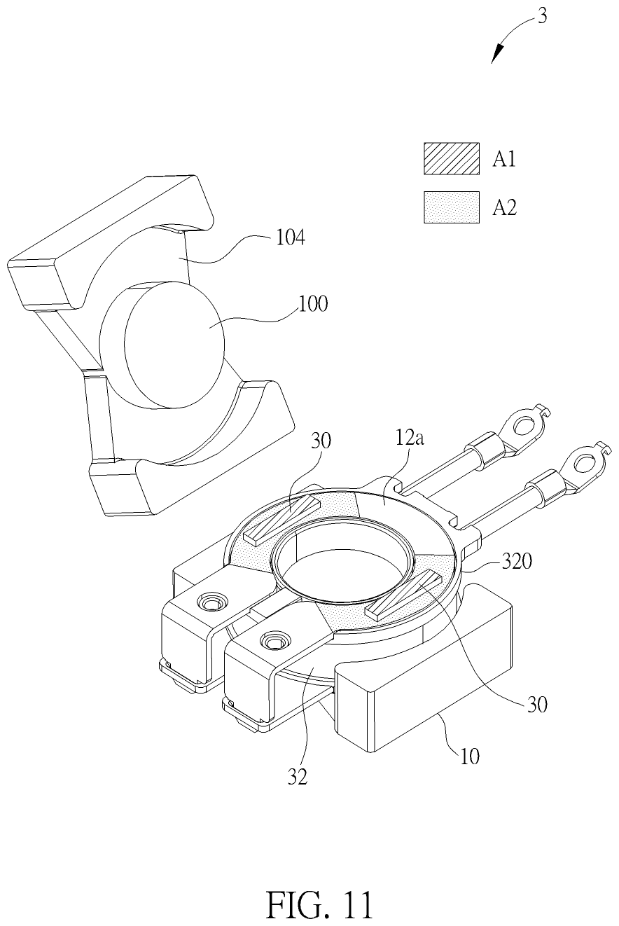

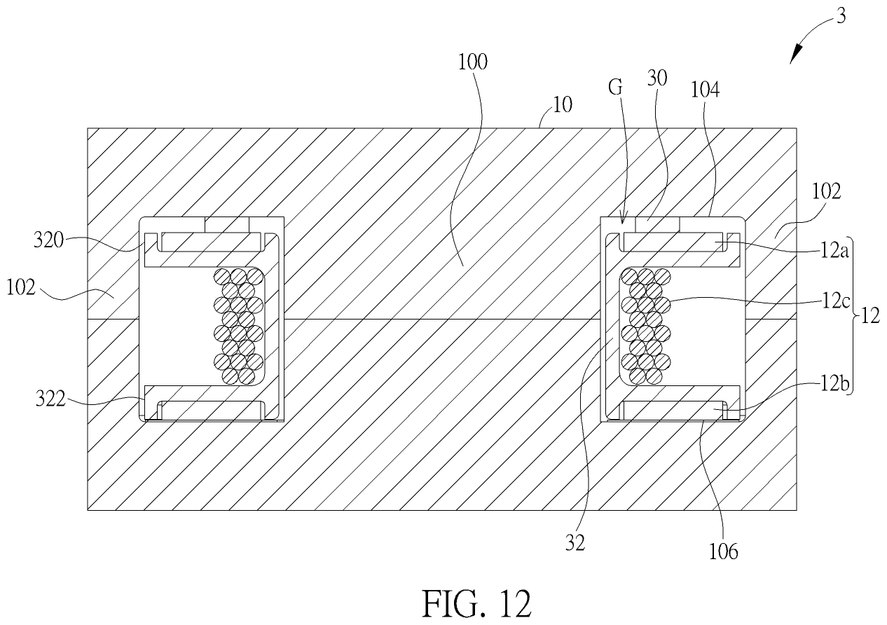

Referring to FIGS. 10 to 12, FIG. 10 is a perspective view illustrating a magnetic component 3 according to another embodiment of the invention, FIG. 11 is a partial exploded view illustrating the magnetic component 3 shown in FIG. 10, and FIG. 12 is a sectional view illustrating the magnetic component 3 shown in FIG. 10.

In an embodiment, the at least one coil 12 may comprise an upper first coil 12a, a lower first coil 12b and a second coil 12c, as shown in FIG. 12. Each of the upper first coil 12a and the lower first coil 12b may be a flat structure, and the second coil 12c may be formed by stacking a circular wire in multiple turns, such that a cross-sectional area of each of the upper first coil 12a and the lower first coil 12b may be larger than a cross-sectional area of the second coil 12c, but the invention is not so limited. The upper first coil 12a is disposed with respect to the upper inner surface 104 of the core 10, the lower first coil 12b is disposed with respect to the lower inner surface 106 of the core 10, and the second coil 12c is disposed between the upper first coil 12a and the lower first coil 12b. The lower first coil 12b, the second coil 12c and the upper first coil 12a are stacked from bottom to top, and there is a gap G between the upper inner surface 104 of the core 10 and the upper first coil 12a, so as to absorb the assembly tolerance.

In this embodiment, the magnetic component 3 further comprises a thermal conductive material 30 partially disposed in the gap G and in contact with the upper first coil 12a and the upper inner surface 104 of the core 10, such that the heat of the upper first coil 12a can be transferred to the upper portion of the core 10 through the thermal conductive material 30, so as to dissipate the heat from the upper first coil 12a. The thermal conductive material 30 may be, but is not limited to, gap filler, thermal pad or other thermal interface materials. Furthermore, there is no gap between the lower inner surface 106 of the core 10 and the lower first coil 12b, the lower first coil 12b is thermally coupled to the lower inner surface 106 of the core 10, and the second coil 12c is not in contact with the thermal conductive material 30.

In this embodiment, as shown in FIG. 11, a ratio of an area A1 of the thermal conductive material 30 to an area A2 of the upper first coil 12a covered by the core 10 may be between 30% and 50%.

In this embodiment, the magnetic component 3 further comprises a bobbin 32 sleeved on the inner leg 100, wherein the bobbin 32 has an upper protruding platform 320 and a lower protruding platform 322 respectively corresponding to the upper inner surface 104 and the lower inner surface 106. The upper first coil 12a is disposed on an upper side of the upper protruding platform 320, and the lower first coil 12b is disposed on a lower side of the lower protruding platform 322, such that the upper first coil 12a is disposed with respect to the upper inner surface 104 of the core 10, and the lower first coil 12b is disposed with respect to the lower inner surface 106 of the core 10. The second coil 12c is located between the upper protruding platform 320 and the lower protruding platform 322, and there is a heat dissipating gap between the second coil 12c and the core 10 or the bobbin 32.

In this embodiment, the current and heat of the upper first coil 12a are larger than the current and heat of the second coil 12c. The usage amount of the thermal conductive material 30 may be reduced by 94% with the aforesaid structure.

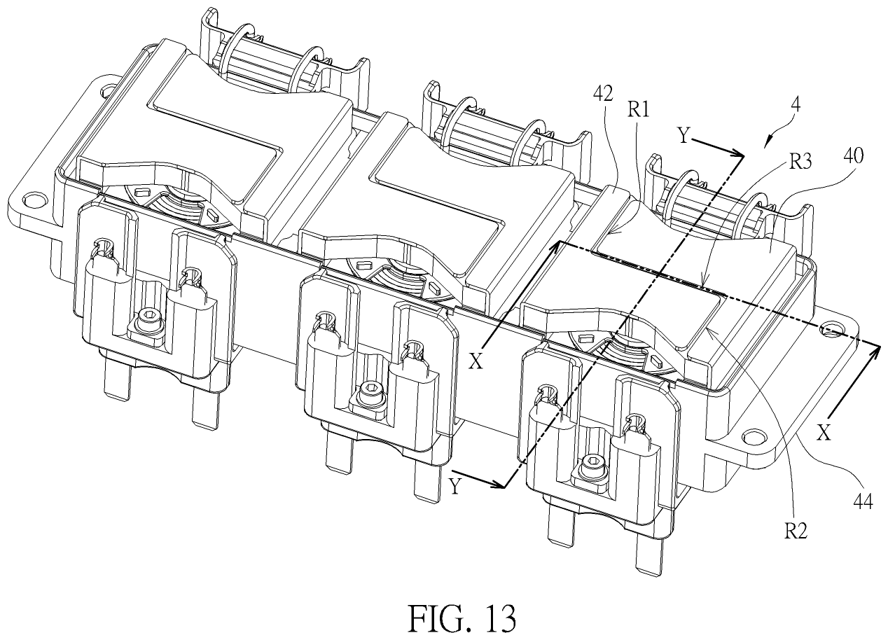

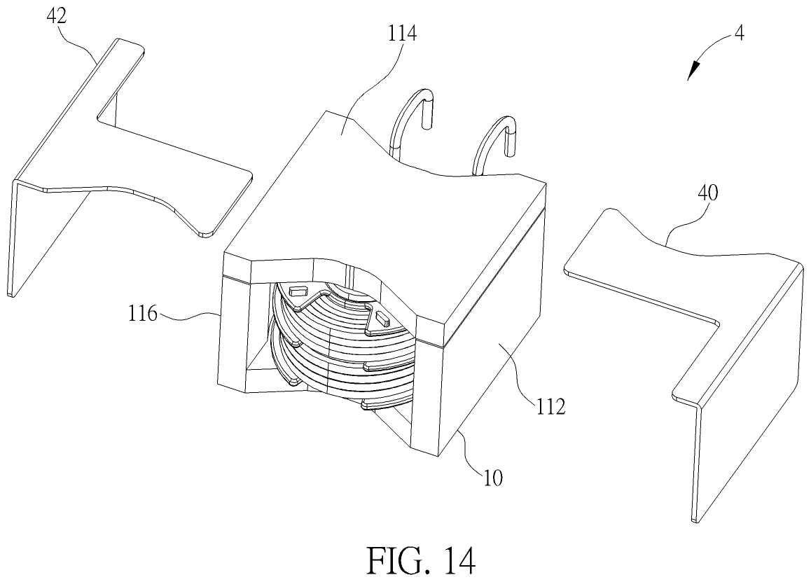

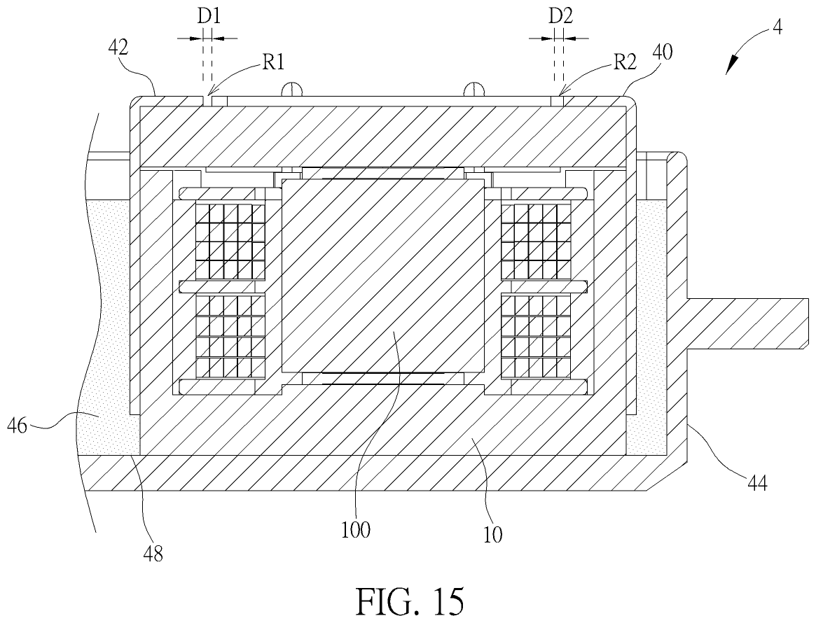

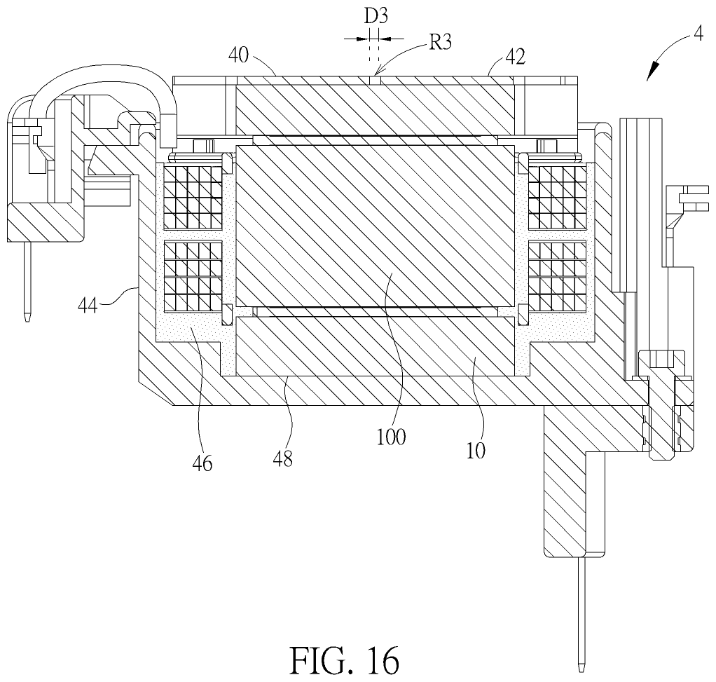

Referring to FIGS. 13 to 16, FIG. 13 is a perspective view illustrating a magnetic component 4 according to another embodiment of the invention, FIG. 14 is a partial exploded view illustrating the magnetic component 4 shown in FIG. 13, FIG. 15 is a sectional view illustrating the magnetic component 4 shown in FIG. 13 along line X-X, and FIG. 16 is a sectional view illustrating the magnetic component 4 shown in FIG. 13 along line Y-Y.

In an embodiment, the magnetic component 4 further comprises a first heat dissipating member 40 and a second heat dissipating member 42, as shown in FIGS. 13 to 16. In this embodiment, three magnetic components 4 may be disposed in a single casing 44, but the invention is not so limited. In one magnetic component 4, the first heat dissipating member 40 may be disposed on a first side 112 and a top side 114 of the core 10, and the second heat dissipating member 42 may be disposed on a second side 116 and the top side 114 of the core 10, wherein the first side 112 is opposite to the second side 116. For further explanation, the first heat dissipating member 40 extends from the first side 112 to the top side 114, and the second heat dissipating member 42 extends from the second side 116 to the top side 114.

In this embodiment, the first heat dissipating member 40 and the second heat dissipating member 42 have a first joint region R1, a second joint region R2 and a third joint region R3 on the top side 114 between the first side 112 and the second side 116. The third joint region R3 is located between the first joint region R1 and the second joint region R2. In this embodiment, the extending direction of the third joint region R3 is perpendicular to the extending directions of the first joint region R1 and the second joint region R2, but the invention is not so limited. Furthermore, projections of the first joint region R1 and the second joint region R2 do not overlap with the inner leg 100, and a projection of at least one of the first heat dissipating member 40 and the second heat dissipating member 42 overlaps with the inner leg 100, as shown in FIGS. 13, 15 and 16.

In this embodiment, the magnetic component further comprises a thermal conductive filler 46 covering a lower portion of the core 10 and thermally coupled to a heat dissipating surface 48 below the lower portion.

To increase the heat dissipating path for the inner leg 100, the projection of at least one of the first heat dissipating member 40 and the second heat dissipating member 42 overlaps with the inner leg 100, such that the heat of the inner leg 100 can be transferred to the thermal conductive filler 46 on the side or below through at least one of the first heat dissipating member 40 and the second heat dissipating member 42, and then transferred to the heat dissipating surface 48 below. Furthermore, the projections of the first joint region R1 and the second joint region R2 do not overlap with the inner leg 100, such that a joint distance D1, D2 of each of the first joint region R1 and the second joint region R2 may be larger than a joint distance D3 of the third joint region R3 to absorb the larger length tolerance of the first heat dissipating member 40 or the second heat dissipating member 42 in the horizontal direction of the core 10 without affecting the heat dissipating efficiency.

Preferably, the projections of the first heat dissipating member 40 and the second heat dissipating member 42 may overlap with the inner leg 100 simultaneously (i.e. the projection of the third joint region R3 may overlap with the inner leg 100), and the joint distance D3 of the third joint region R3 may be between 0 and 3 mm. Preferably, the joint distance D3 of the third joint region R3 may be 0, i.e. the first heat dissipating member 40 and the second heat dissipating member 42 are in contact with each other at the third joint region R3, and the first heat dissipating member 40 and the second heat dissipating member 42 may be symmetrical structures, such that the heat of the inner leg 100 transferred to the bottom of the first side 112 through the first heat dissipating member 40 is substantially equal to the heat of the inner leg 100 transferred to the bottom of the second side 116 through the second heat dissipating member 42, so as to optimize the heat dissipating efficiency and reduce the manufacturing cost.

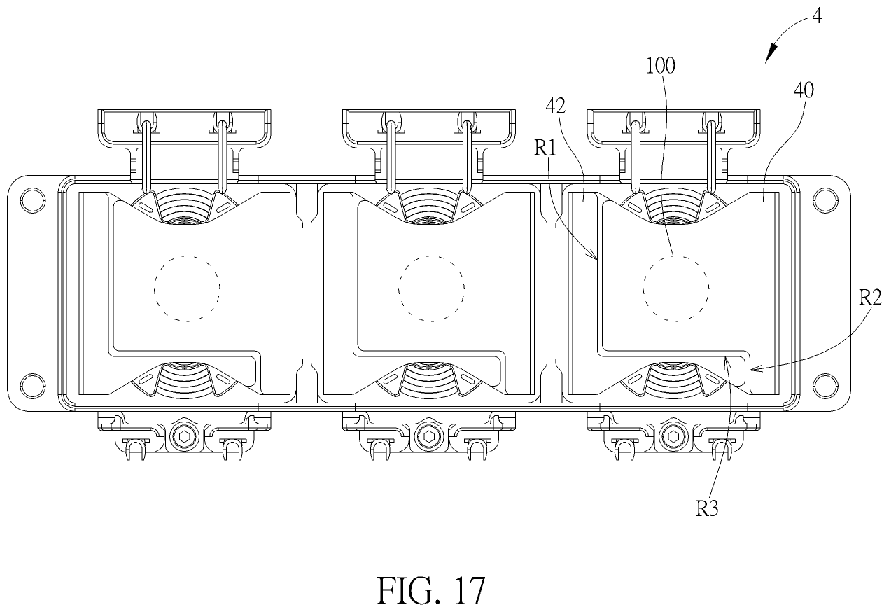

Referring to FIG. 17, FIG. 17 is a top view illustrating the magnetic component 4 according to another embodiment of the invention. As shown in FIG. 17, the projection of the first heat dissipating member 40 overlaps with the inner leg 100, but the projection of the second heat dissipating member 42 does not overlap with the inner leg 100 (i.e. the projection of the third joint region R3 does not overlap with the inner leg 100).

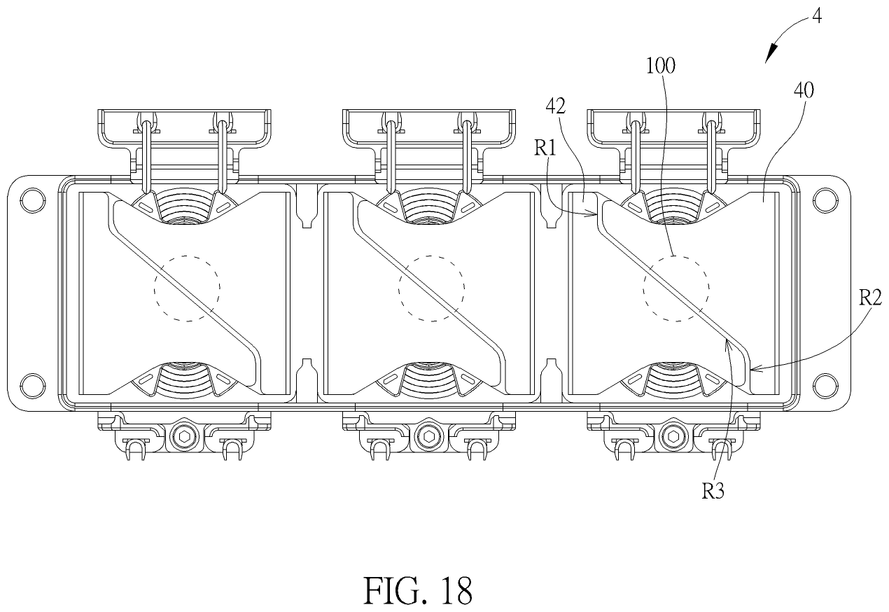

Referring to FIG. 18, FIG. 18 is a top view illustrating the magnetic component 4 according to another embodiment of the invention. As shown in FIG. 18, the extending direction of the third joint region R3 is inclined with respect to the extending directions of the first joint region R1 and the second joint region R2.

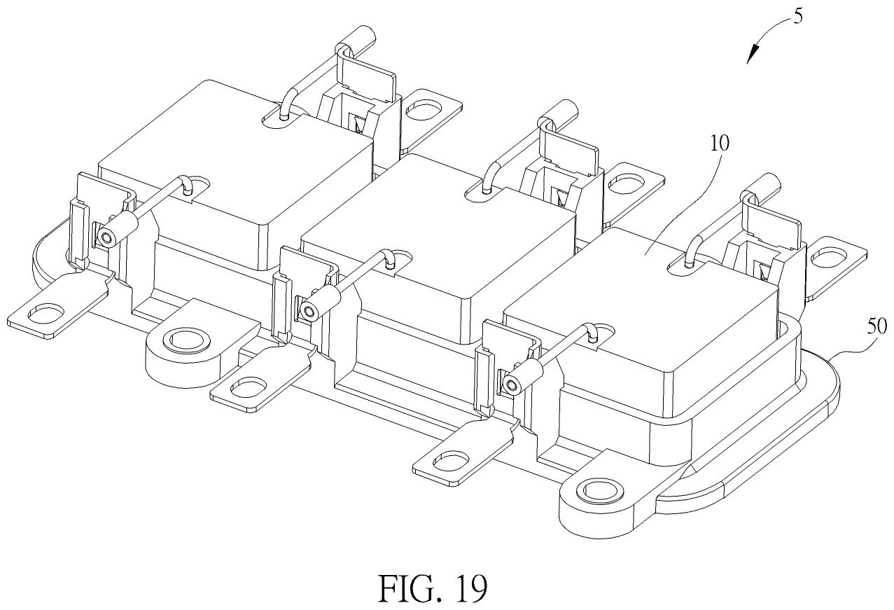

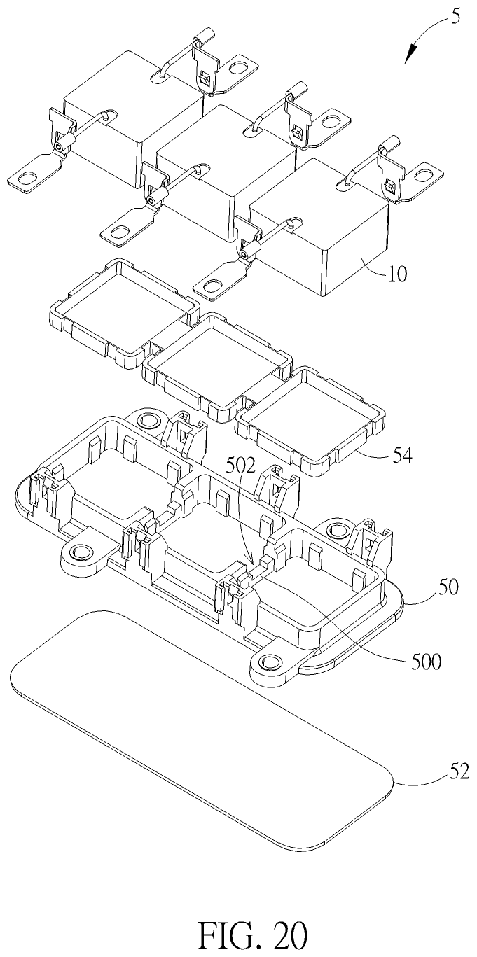

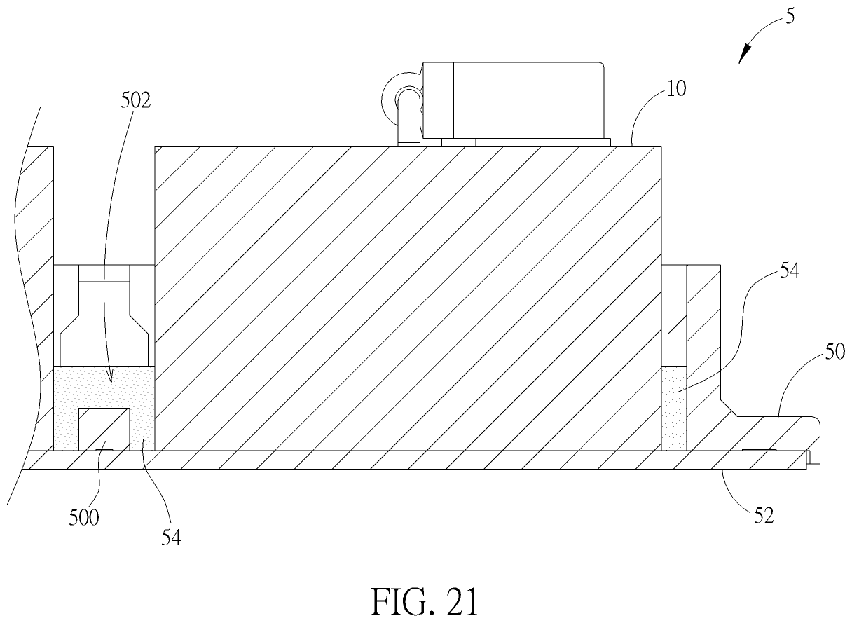

Referring to FIGS. 19 to 21, FIG. 19 is a perspective view illustrating a magnetic component 5 according to another embodiment of the invention, FIG. 20 is an exploded view illustrating the magnetic component 5 shown in FIG. 19, and FIG. 21 is a sectional view illustrating the magnetic component 5 shown in FIG. 19.

In an embodiment, the magnetic component 5 further comprises a plastic casing 50, an insulating and thermal conductive substrate 52, and a thermal conductive filler 54, as shown in FIGS. 19 to 21. In this embodiment, three magnetic components 5 may be disposed in a single plastic casing 50, but the invention is not so limited. The plastic casing 50 is disposed on the insulating and thermal conductive substrate 52, the core 10 of the magnetic component 5 is disposed in the plastic casing 50 and located on the insulating and thermal conductive substrate 52, and the thermal conductive filler 54 is filled in the plastic casing 50.

When the magnetic component with a casing made of aluminum is applied to a high-voltage device (e.g. larger than 67V), it is necessary to dispose an insulating layer inside the casing, which is costly and has poor insulation. Thus, in this embodiment, the casing 50 of the magnetic component 5 made of plastic not only has better insulation, but also can concentrate and transfer most of the heat to the insulating and thermal conductive substrate 52 on the bottom. Furthermore, when filling the thermal conductive filler 54, the plastic casing 50 can be used to cover the thermal conductive filler 54. In this embodiment, the thermal conductive substrate 52 may be a metal core printed circuit board (MCPCB), a ceramic printed circuit board or an aluminum board with insulating layer, which has high thermal conductivity and high insulation at the same time.

As shown in FIGS. 20 and 21, the plastic casing 50 may have a retracted structure 500 and a flow guide opening 502, and the thermal conductive filler 54 may cover the retracted structure 500 and the flow guide opening 502. For further explanation, the wall between the magnetic components 5 may have the flow guide opening 502, such that the thermal conductive filler 54 may flow between the magnetic components 5 through the flow guide opening 502 as being filled. In addition, the bottom of the plastic casing 50 may further have the retracted structure 500, such that the thermal conductive filler 54 may cover the retracted structure 500 and the flow guide opening 502, so as to reduce the usage amount of the thermal conductive filler 54.

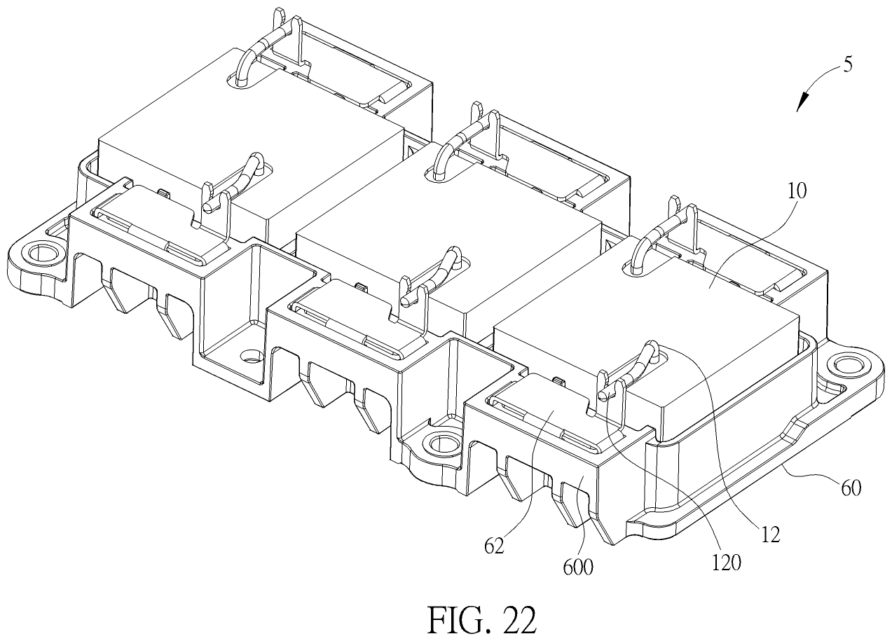

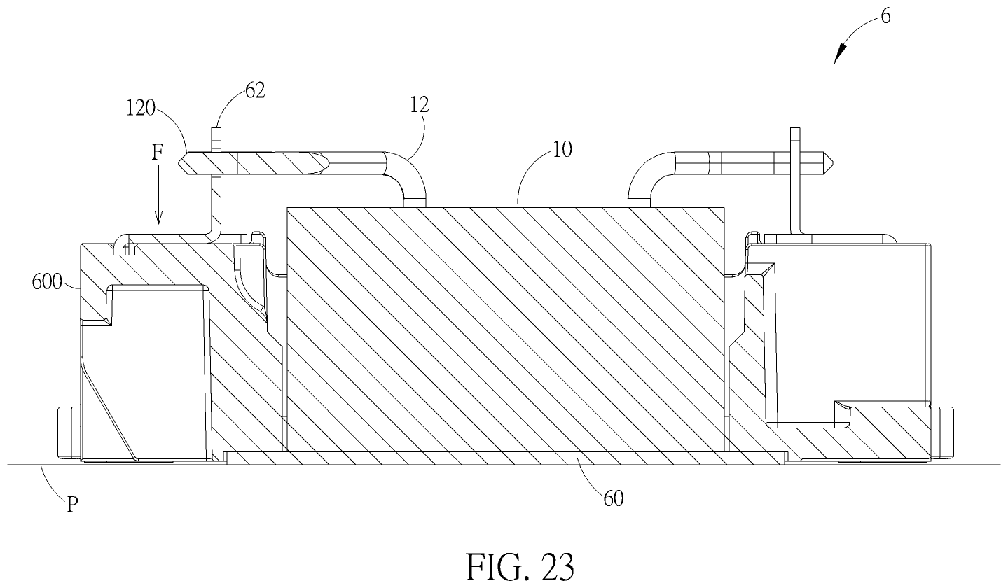

Referring to FIGS. 22 and 23, FIG. 22 is a perspective view illustrating a magnetic component 6 according to another embodiment of the invention, and FIG. 23 is a sectional view illustrating the magnetic component 6 shown in FIG. 22.

In an embodiment, the magnetic component 6 further comprises a casing 60, as shown in FIGS. 22 and 23. The casing 60 has a support structure 600. A terminal 62 is disposed on the support structure 600. An end 120 of the at least one coil 12 is bonded with the terminal 62 on the support structure 600. The support structure 600 extends downward from the terminal 62 to a support plane P where the casing 60 is located.

In this embodiment, since the support structure 600 extends downward from the terminal 62 to the support plane P where the casing 60 of the magnetic component 6 is located, the bonding force F for bonding the end 120 of the coil 12 with the terminal 62 will be directly transferred to the support plane P through the support structure 600, such that the support structure 600 may withstand, for example, 650 tons of the bonding force F. It should be noted that the shape of the support structure 600 may be determined according to practical applications, so the invention is not limited to the embodiment shown in the figure.

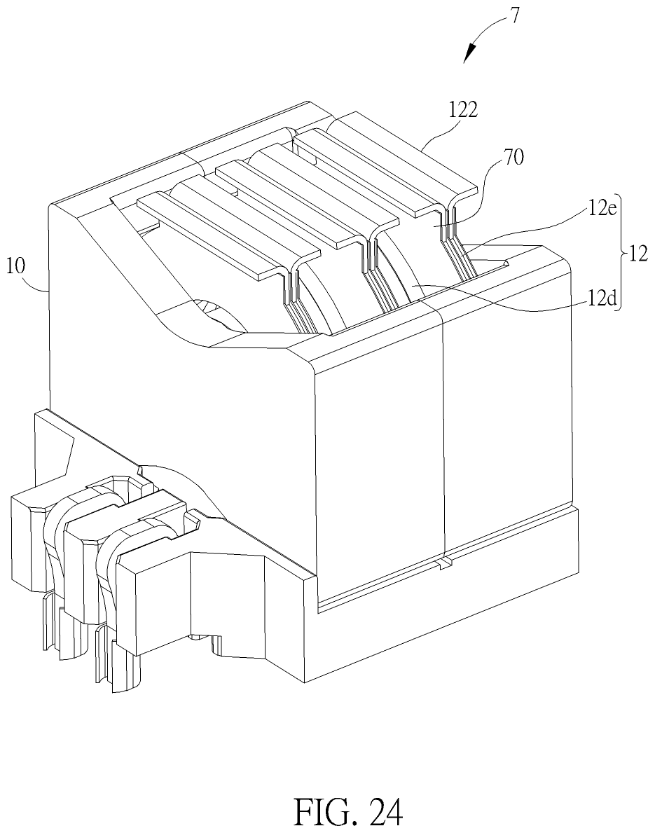

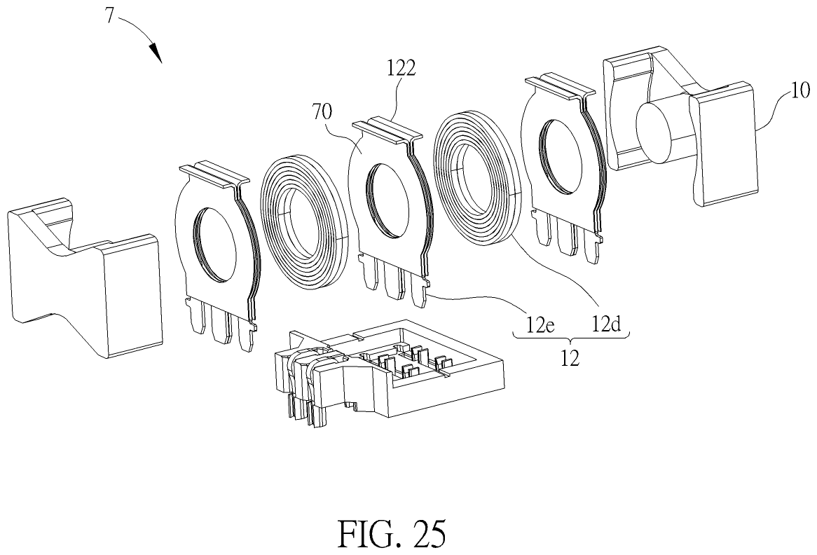

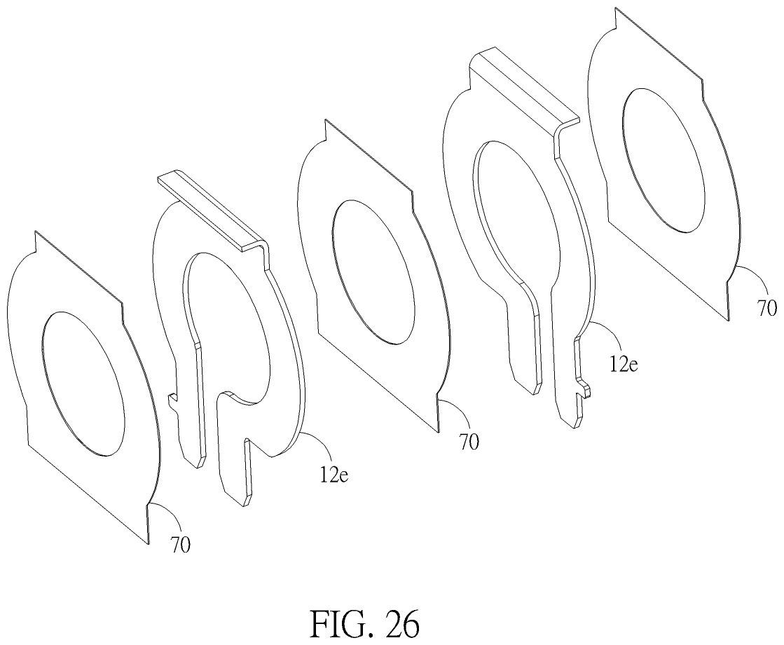

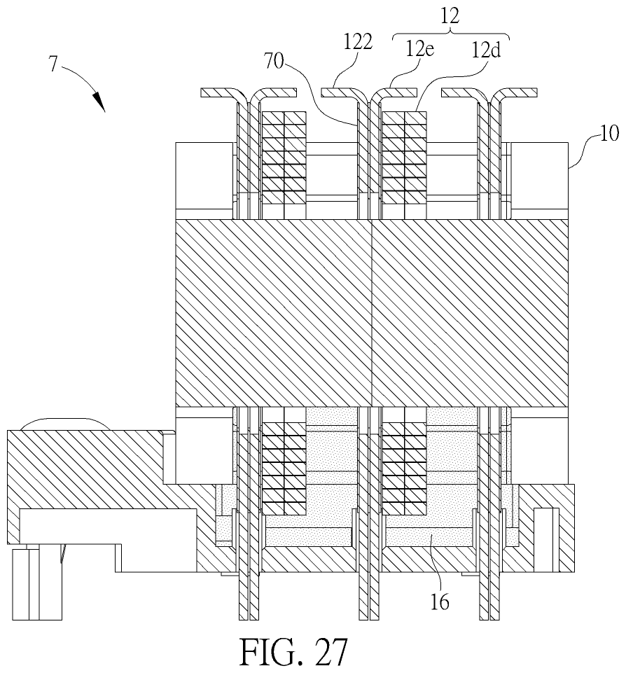

Referring to FIGS. 24 to 27, FIG. 24 is a perspective view illustrating a magnetic component 7 according to another embodiment of the invention, FIG. 25 is an exploded view illustrating the magnetic component 7 shown in FIG. 24, FIG. 26 is an exploded view illustrating the secondary coils 12e and the insulating spacers 70 shown in FIG. 25, and FIG. 27 is a sectional view illustrating the magnetic component 7 shown in FIG. 24.

In an embodiment, the at least one coil 12 comprises at least one primary coil 12d and at least one secondary coil 12e stacked with each other, as shown in FIGS. 24 to 27. The at least one primary coil 12d may be formed by stacking a circular wire in multiple turns. The at least one secondary coil 12e may be a foil structure. As shown in FIG. 27, the at least one secondary coil 12e has a heat dissipating portion 122 protruding from the core 10, and the at least one primary coil 12d is retracted between the at least one secondary coil 12e without extending to the heat dissipating portion 122 of the at least one secondary coil 12e. The number of the primary coil 12d and the secondary coil 12e may be determined according to practical applications. In this embodiment, the magnetic component 7 further comprises a thermal conductive filler 16 partially filled between the at least one primary coil 12d and the at least one secondary coil 12e.

In this embodiment, a number of turns of the at least one primary coil 12d may be larger than a number of turns of the at least one secondary coil 12e. Furthermore, the cross-sectional area, current and heat of the secondary coil 12e may be larger than those of the primary coil 12d. Thus, the heat dissipating portion 122 of the secondary coil 12e may be in contact with a heat dissipating surface of a radiator (not shown), so as to increase the heat dissipating area of the magnetic component 7. Furthermore, the heat of the retracted primary coil can be transferred to an external heat dissipating interface through the thermal conductive filler 16 and the secondary coil 12e, so as to achieve better heat dissipating efficiency in a more economical (lower cost) manner.

Furthermore, the magnetic component 7 may further comprise at least one insulating spacer 70 disposed between the at least one primary coil 12d and the at least one secondary coil 12e, so as to improve insulation between the primary coil 12d and the secondary coil 12e. The thickness of the insulating spacer 70 may be between 50 μm and 100 μm, but the invention is not so limited.

It should be noted that the inner leg 100 at least partially divided into a plurality of separated portions 1000 (as shown in FIGS. 2-5) can be applied to all of the magnetic components 2-7 mentioned in the above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a core comprising at least one outer leg and an inner leg, the inner leg being separated from an upper inner surface of the core, the inner leg being at least partially divided into a plurality of separated portions along a length direction of the inner leg; and
at least one coil wound around the inner leg.

2. The magnetic component of claim 1, wherein at least one individual portion of the inner leg is separated from a lower inner surface of the core, such that the at least one individual portion of the inner leg is floated or separated between the upper inner surface and the lower inner surface.

3. The magnetic component of claim 1, wherein a length of the plurality of separated portions is larger than ⅓ of a length of the inner leg.

4. The magnetic component of claim 1, wherein the inner leg is cut through a center, and volumes of the plurality of separated portions are identical to each other.

5. The magnetic component of claim 1, wherein a thermal conductive sheet with a thermal conductivity greater than a thermal conductive filler is disposed between the separated portions of the inner leg and combined with the thermal conductive filler covering the inner leg.

6. The magnetic component of claim 1, further comprising a heat dissipating member and a thermal conductive filler, wherein the heat dissipating member is disposed on the core, the heat dissipating member is in contact with a top surface and a side surface of the core, the side surface has an opening, the heat dissipating member covers the opening, the thermal conductive filler is filled at the opening of the side surface and covers a part of the at least one coil rather than wholly covering the at least one coil, a shape of the thermal conductive filler at the opening is identical to a shape of the opening covered by the heat dissipating member, an end of the at least one coil protrudes from the core, and the heat dissipating member has a protruding portion thermally coupled to the end of the at least one coil.

7. The magnetic component of claim 6, wherein an insulating member is disposed between the end of the at least one coil and the protruding portion of the heat dissipating member.

8. The magnetic component of claim 1, wherein the at least one coil comprises an upper first coil, a lower first coil and a second coil, a cross-sectional area of each of the upper first coil and the lower first coil is larger than a cross-sectional area of the second coil, the upper first coil is disposed with respect to the upper inner surface of the core, the lower first coil is disposed with respect to a lower inner surface of the core, the second coil is disposed between the upper first coil and the lower first coil; wherein the lower first coil, the second coil and the upper first coil are stacked from bottom to top, there is a gap between the upper inner surface of the core and the upper first coil; wherein the magnetic component further comprises a thermal conductive material partially disposed in the gap and in contact with the upper first coil and the upper inner surface of the core, there is no gap between the lower inner surface of the core and the lower first coil, the lower first coil is thermally coupled to the lower inner surface of the core, and the second coil is not in contact with the thermal conductive material.

9. The magnetic component of claim 8, wherein a ratio of an area of the thermal conductive material to an area of the upper first coil covered by the core is between 30% and 50%.

10. The magnetic component of claim 8, wherein each of the upper first coil and the lower first coil is a flat structure, and the second coil is formed by stacking a circular wire in multiple turns.

11. The magnetic component of claim 8, further comprising a bobbin sleeved on the inner leg, wherein the bobbin has an upper protruding platform and a lower protruding platform respectively corresponding to the upper inner surface and the lower inner surface, the upper first coil is disposed on an upper side of the upper protruding platform, the lower first coil is disposed on a lower side of the lower protruding platform, the second coil is located between the upper protruding platform and the lower protruding platform, and there is a heat dissipating gap between the second coil and the core or the bobbin.

12. The magnetic component of claim 1, further comprising:
a first heat dissipating member disposed on a first side and a top side of the core, the first heat dissipating member extending from the first side to the top side; and
a second heat dissipating member disposed on a second side and the top side of the core, the first side being opposite to the second side, the second heat dissipating member extending from the second side to the top side;
wherein the first heat dissipating member and the second heat dissipating member have a first joint region, a second joint region and a third joint region on the top side between the first side and the second side, the third joint region is located between the first joint region and the second joint region, projections of the first joint region and the second joint region do not overlap with the inner leg, and a projection of at least one of the first heat dissipating member and the second heat dissipating member overlaps with the inner leg.

13. The magnetic component of claim 12, wherein a projection of the third joint region overlaps with the inner leg.

14. The magnetic component of claim 12, wherein a joint distance of each of the first joint region and the second joint region is larger than a joint distance of the third joint region.

15. The magnetic component of claim 12, wherein a joint distance of the third joint region is between 0 and 3 mm.

16. The magnetic component of claim 12, further comprising a thermal conductive filler covering a lower portion of the core and thermally coupled to a heat dissipating surface below the lower portion.

17. The magnetic component of claim 12, wherein the first heat dissipating member and the second heat dissipating member are symmetrical structures.

18. The magnetic component of claim 12, wherein the first heat dissipating member and the second heat dissipating member are in contact with each other at the third joint region.

19. The magnetic component of claim 1, further comprising a plastic casing, an insulating and thermal conductive substrate, and a thermal conductive filler, wherein the plastic casing is disposed on the insulating and thermal conductive substrate, the core is disposed in the plastic casing and located on the insulating and thermal conductive substrate, and the thermal conductive filler is filled in the plastic casing.

20. The magnetic component of claim 19, wherein the plastic casing has a retracted structure and a flow guide opening, and the thermal conductive filler covers the retracted structure and the flow guide opening.

21. The magnetic component of claim 1, further comprising a casing, wherein the casing has a support structure, a terminal is disposed on the support structure, an end of the at least one coil is bonded with the terminal on the support structure, and the support structure extends downward from the terminal to a support plane where the casing is located.

22. The magnetic component of claim 1, wherein the at least one coil comprises at least one primary coil and at least one secondary coil stacked with each other, the at least one primary coil is formed by stacking a circular wire in multiple turns, the at least one secondary coil is a foil structure, the at least one secondary coil has a heat dissipating portion protruding from the core, the at least one primary coil is retracted between the at least one secondary coil without extending to the heat dissipating portion of the at least one secondary coil, and the magnetic component further comprises a thermal conductive filler partially filled between the at least one primary coil and the at least one secondary coil.

23. The magnetic component of claim 22, wherein a number of turns of the at least one primary coil is larger than a number of turns of the at least one secondary coil.

24. The magnetic component of claim 22, further comprising at least one insulating spacer disposed between the at least one primary coil and the at least one secondary coil.
